(19) United States
(12) Patent Application Publication
(10) Pub. No.: US 2026/0104904 A1
(43) Pub. Date: Apr. 16, 2026

(54) Contextually-Refined Query Processing for Retrieval-Augmented Response Generation

(71) Applicant: Webflow, Inc., San Francisco, CA (US)

(72) Inventors: Fernando López Martínez, Mexico City (MX); Jay Papisan, Berkeley, CA (US); Jeremy Collins, Anaheim, CA (US); Jeremy Toce, Los Angeles, CA (US); Nicholas Spencer, San Francisco, CA (US); Tao Pan, Issaquah, WA (US); Tristan Tarpley, Houston, TX (US); Vikram Chandvankar, Miami Beach, FL (US)

(21) Appl. No.: 19/357,653

(22) Filed: Oct. 14, 2025

Related U.S. Application Data
(60) Provisional application No. 63/707,167, filed on Oct. 14, 2024.
(60) Provisional application No. 63/707,158, filed on Oct. 14, 2024.

(51) Int. Cl. G06F 9/451; G06F 16/334; G06F 40/30

(52) U.S. Cl. CPC G06F 9/451; G06F 16/3347; G06F 40/30

(57) ABSTRACT

Systems and techniques may increase user productivity and reduce the learning curve for complex web design tools. In some implementations, data specifying a baseline query associated with an application is received. A workspace context of the application corresponding to the baseline query is determined. A refined query is generated by modifying the baseline query based on the workspace context. Data representing a vector representation that is semantically relevant to the refined query is obtained from one or more vector databases. Prompt data for one or more trained machine learning models is generated based on the refined query and the vector representation. Output data generated by the one or more machine learning models based on the prompt data is obtained. An instruction is provided for output to a computing device, where the instruction causes the first computing device to display a representation of the output data through the application.

### CROSS-REFERENCE TO RELATED APPLICATIONS

This application claims the benefit of U.S. Provisional Application Nos. 63/707,158 and 63/707,167, each filed on Oct. 14, 2024, the contents of which are incorporated by reference in their entirety.

### TECHNICAL FIELD

This disclosure generally describes technology relating to machine learning, and more particularly, to technology related to the integration of machine learning to cloud-based software platforms.

### BACKGROUND

Machine learning (ML) enables systems to learn from data and improve their performance without being explicitly programmed for every task. Rather than following predefined rules, ML systems build models based on patterns found in large datasets. These models may make predictions, classify data, or perform decision-making tasks based on new, unseen data. ML may involve providing input data into a trained model, which processes the provided data to identify patterns or relationships within the data.

ML may involve several types of learning. For example, in supervised learning, a model is trained on labeled data, where both the inputs and desired outputs are known. The goal is to learn a mapping from inputs to outputs to make predictions on new, unlabeled data. As another example, in unsupervised learning, a model works with data that has no labeled outcomes. Another example is reinforcement learning, where a model learns by interacting with an environment and receiving feedback in the form of rewards or penalties. ML has applications across industries, including healthcare, finance, and consumer-focused technologies. In the context of healthcare, ML systems and techniques may be useful to predict diseases, analyze medical images, and provide other advantages.

Information retrieval systems typically receive a user query and match the query against an index constructed from a corpus of documents. The index may be created by parsing documents, extracting terms and features, and building data structures that map terms to document locations. Candidate results are identified using lexical signals such as term frequency, inverse document frequency, and field weighting, and are ranked by relevance scores. ML may be used to automate and improve these stages, including query understanding, document representation, candidate generation, and ranking.

### SUMMARY

This disclosure is focused on systems and techniques that address limitations of certain information retrieval systems by grounding ML-assisted responses in a knowledge base that is periodically curated within a content management system (CMS) and retrieved using retrieval-augmented generation (RAG). For example, the disclosed systems may increase user productivity and reduce the learning curve for complex web design tools by aligning information retrieval to the user's workspace context. In such implementations, a refined query reflects the project type, elements on the canvas, and the user's skill level, which increases the relevance and usefulness of returned information. The knowledge base may be maintained as multimodal content that is segmented into content chunks and embedded as vector representations, with incremental updates that add, modify, or deprecate entries to reduce stale or outdated guidance.

For example, a user may access an ML interface (e.g., chat-based text interface) to provide a baseline query (e.g., request for information regarding an authoring tool) from an application (e.g., web design application, web development application). The system determines a workspace context associated with the query (e.g., user is designing a component within a webpage) and generates a refined query that conditions the user's request based on application state. Using the refined query, the system obtains one or more vector representations from one or more vector databases that store embeddings of a multimodal knowledge base. The system constructs a prompt for one or more ML models based on the refined query and the retrieved vector representation, and obtains output generated by the models. The system provides an instruction that causes the application to display a representation of the output, thereby supplying relevant, real-time assistance that improves the usability of complex design tooling while preserving low-latency interaction.

The disclosed systems and techniques address limitations of certain information retrieval systems by grounding ML-assisted responses in a first-party knowledge base that is periodically curated within a content management system (CMS) and retrieved using retrieval-augmented generation (RAG). In some implementations, systems align retrieval to the user's workspace context so that the refined query reflects the project type, elements on the canvas, and the user's skill level, which increases the relevance and usefulness of returned information. The knowledge base may be maintained as multimodal content that is segmented into content chunks and embedded as vector representations, with incremental updates that add, modify, or deprecate entries to reduce stale or outdated guidance.

During runtime, a refined query drives semantic retrieval from one or more vector databases, and the system constructs prompt data that conditions the model on the retrieved chunks and the workspace context to reduce off-topic or generic answers. The CMS may record up-to-date metadata, source identifiers, and version history so that retrieval methods prefer current materials and avoid superseded content. User feedback may also be captured and used to re-weight retrieval and prompt policies over time, thereby improving relevance determinations and maintaining alignment with evolving product features and best practices. Collectively, the RAG pipeline and recursively updated CMS knowledge base deliver context-appropriate, current, and trustworthy outputs within the application.

The systems and techniques disclosed herein may also leverage ML to improve website development with varying levels of process automation. For example, a site controller may type a natural language request asking for a five-page marketing microsite, and an ML model may generate the corresponding page structures, themed style tokens, component markup, and placeholder media. The build pipeline compiles these assets, writes them to the artifact repository, and publishes them through the edge delivery layer without the controller writing any code. As another example, when a site controller requests a redesigned testimonial slider, a ML model may query a content database to understand existing collection fields and reference links and generates an updated component that preserves field binding relationships. The build system validates the generated markup against the CMS schema, updates only the affected bundle, and deploys the component so the new slider renders correctly across all locales without breaking any data driven pages.

In various implementations, the systems may use ML models to refine or extend existing websites after initial deployment. For example, a controller may prompt an assistant to translate all product collection items into Spanish and adjust the layout for right-to-left reading flows. The inference connector enriches the prompt with collection records from the content database, the language model returns translated strings and updated style rules, and the build system regenerates only the affected locale bundles, so the localized version appears online with minimal delay.

In one general aspect, this disclosure is focused on a computer-implemented method that includes a set of operations. The operations include receiving, by a server and from a computing device, data specifying a baseline query associated with an application. The operations also include determining, by the server, a workspace context of the application corresponding to the baseline query. Further, the operations include generating, by the server, a refined query by modifying the baseline query based on the workspace context. Additional operations include obtaining, by the server and from one or more vector databases, data representing a vector representation that is semantically relevant to the refined query. The vector representation is identified from among a plurality of vector representations based on the refined query. Prompt data is generated by the server for one or more machine learning models based on the refined query and the vector representation. The operations also include obtaining data representing an output generated by the one or more machine learning models based on the prompt, and providing, to the computing device, an instruction that, when received by the computing device, causes the computing device to display a representation of the output data through the application.

One or more implementations may include the following optional features. For example, in some implementations, the baseline query is provided at a first time in relation to a graphical user interface of the application. In such implementations, the workspace context comprises one or more design elements displayed on the graphical user interface at the first time.

In some implementations, the workspace context specifies a project type of a web application that is accessed through the application at the first time.

In some implementations, the plurality of vector representations correspond to content chunks segmented from a multi-modal knowledge base of web design concepts.

In some implementations, the method includes additional operations. For instance, the operations further include accessing, by the server, content specified by a multi-modal knowledge base specified within a content management system associated with the application. In such implementations, the operations further include identifying a set of boundary conditions for the content specified by the multi-modal knowledge base, and segmenting, by the server, the content from the multi-modal knowledge base into a plurality of content chunks.

In some implementations, the operation of identifying the set of boundary conditions for the content specified by the multi-modal knowledge base includes further steps. For example, the operation includes calculating a semantic similarity score between (i) a first text segment within content specified by the multi-modal knowledge base and (ii) a second text segment within content specified by the multi-modal knowledge base. In such implementations, the operations further includes determining that the semantic similarity score satisfies a predetermined semantic similarity threshold.

In some implementations, the one or more machine learning models comprise a large language model (LLM).

In some implementations, the data specifying the baseline query is received by the server at a first time point. In such implementations, the instruction that causes the computing device to display the representation of the output data is provided by the server at a second time point. Additionally, a time period between the first time point and the second time point is less than a predetermined time threshold.

In some implementations, the predetermined time is three seconds.

The details of one or more implementations are set forth in the accompanying drawings and the description below. Other features, objects, and advantages of the invention will be apparent from the description and drawings, and from the claims.

### BRIEF DESCRIPTION OF DRAWINGS

FIG. 1 illustrates an example of a technique enabling ML-assisted guidance using retrieval-augmented generation over a maintained knowledge base of a content management system.

FIG. 2 illustrates an example of a system that enables a web experience platform (WEP) for supporting web development using one or more ML models.

FIG. 3 illustrates an example of an architecture for using retrieval-augmented generation to retrieve contextually relevant information from a content management system.

FIG. 4 illustrates a flow chart for an example of a process for using retrieval-augmented generation over a maintained knowledge base of a content management system.

In the drawings, like reference numbers represent corresponding parts throughout.

### DETAILED DESCRIPTION

The systems and methods described within this disclosure improve various aspects of automated information retrieval through use RAG and knowledge base management within a CMS. For example, a system may improve the relevancy of retrieved information by monitoring a workspace context representing a usage state of an application. The content, format, and presentation of retrieved information may be adapted based on the workspace context to improve the likelihood that a user perceives the retrieved information to be useful to their submitted query.

As an example, a system receives a baseline query based on input provided by a user through a graphical interface. The system determines a workspace context for that query and generates a refined query that better reflects a user's task. Using the refined query, the system obtains semantically relevant vector representations from one or more vector databases populated from curated materials. The system constructs a prompt data for one or more ML models, obtains model output based on the prompt, and returns an instruction that causes the application to display a representation of the output. In some instances, this process may be used to enable, for instance, an on-demand automated assistant that may respond to user requests for information in various usage scenarios associated with an application (e.g., website design application, website development application).

A workspace context specifies information describing the state of an application at or around the time a user submits a baseline query. The workspace context may identify this state by specifying various types of information, such as the active page or route, an element or component selection, a component hierarchy snapshot, currently visible panels and settings, responsive breakpoints, recent authoring actions, a project-type label indicating the class of site being developed, among others. The workspace context may further include user-specific attributes such as a role or skill tier determined from historical interactions to tailor the level of detail in responses. Context data may further be obtained from a client-side software development kit (SDK), from server-side session state, or from both. In privacy-aware deployments, the collection process may redact user content while retaining structural identifiers sufficient for retrieval and answer construction.

A baseline query represents an initial request captured from an application's graphical interface, for example, a chat panel or other ML interface. The system generates a refined query by modifying the baseline query based on the workspace context. Refinement may include text normalization, disambiguation of element names using the context, insertion of project-type or layout terminology, skill-appropriate templating so that the retriever and the model receive task-aligned input, among others. A gating stage may determine whether the question is answerable from the maintained knowledge base and may request clarification if required. Conversation threading and history tracking may be used so that follow-up questions inherit context without re-specifying prior details.

Information retrieval is also based on a knowledge base of web design concepts, tutorials, best-practice documents, and product references managed through a CMS. This ensures that outputs accurately reflect up-to-date features and/or capabilities provided through the application without requiring manual updates. For instance, the system accesses the knowledge base, identifies boundary conditions for individual sources, and segments the sources into content chunks that preserve semantic coherence and modality tags. Boundary conditions may be determined using size limits, heading markers, caption cues, and semantic-similarity thresholds between adjacent segments so that related material is merged while unrelated material remains separated. Each content chunk is embedded to produce a vector representation stored in one or more vector databases. At runtime, the refined query drives retrieval over these vector representations, and the system constructs a prompt that includes the refined query, selected chunks, and the workspace context for one or more ML models such as a large language model. The resulting model output is converted into an instruction that, when received by the application, causes the interface to display a representation of the output aligned to the user's task.

Further, the information retrieval techniques disclosed herein are directed to improvements to problems that uniquely arise in computer-related technology. As described herein, the techniques improve how networked computing systems retrieve and serve information under accuracy and latency constraints using specialized data structures and machine operations. This operates on machine-generated signals (e.g., workspace context captured from application state, content chunks with up-to-date metadata, high-dimensional vector representations stored in one or more vector databases) and applies computer-implemented processes (e.g., semantic similarity search, query expansion, prompt assembly) that conditions ML models on retrieved passages and session metadata. These steps change the functioning of the computer by reducing off-topic results, enforcing recency via CMS-managed updates, and meeting a defined end-to-end time threshold from query receipt to UI display. Manual analogs of these operations result in a fundamentally different process.

For instance, a person cannot observe and identify a workplace context within a specified time period (e.g., less than three seconds), compute nearest neighbors over multimodal embeddings, or orchestrate model routing and caching to satisfy timing imitations associated with the distributed services. The operations involved in the disclosed information retrieval techniques disclosed herein therefore addresses problems unique to computerized information retrieval (context loss, staleness, and scale) and constitutes a specific improvement in the operation of computer systems.

Moreover, the information retrieval techniques disclosed herein involve elements specific to computer-related technology, such as vector databases and RAG to generate information outputs. A vector database transforms heterogeneous source content into machine-optimized representations that enable sub-second retrieval for prompt construction and retrieval-augmented generation. Raw documents may be segmented into content chunks and passed through an embedding model that maps each chunk into a high-dimensional numeric vector whose coordinates encode semantic relationships. The database persists these vectors in specialized indexes, such as graph- or quantization-based nearest-neighbor structures with cache-aligned layouts, precomputed centroids, and distance metrics. A refined query may be embedded once and matched against millions of candidates in time budgets suitable for interactive use. Each stored vector is keyed to a source passage, up-to-date metadata, and version identifiers so the retriever may return current and authoritative chunks that may be injected into an ML prompt without additional parsing.

Data transformations involved in generating embeddings for storage in a vector database make them distinct from mental steps used by humans in storing information. Embeddings are opaque numeric arrays, and similarity search requires parallel numeric kernels over high-dimensional spaces, and the ranking policies that trade recall for latency depend on index statistics and hardware locality. Accordingly, the transformed format of embeddings and their retrieval from a vector database using RAG represent a computer-specific optimization that enables the disclosed information retrieval techniques to supply relevant context to ML models at speeds no manual process could achieve (e.g., within three seconds).

As described herein, “machine learning” refers to a class of computational techniques and models, including to neural networks, transformer-based architectures, generative artificial intelligence, decision trees, support vector machines, clustering algorithms, and statistical learning methods. These techniques and models enable a computer system to automatically learn patterns or representations from data and improve performance on a given task without being explicitly programmed with task-specific rules. ML systems may operate in supervised, unsupervised, semi-supervised, reinforcement, or self-supervised learning paradigms, and may be designed to perform a wide range of tasks such as classification, prediction, generation, translation, anomaly detection, and optimization across various data modalities, including text, images, audio, video, and structured data.

As described herein, a “model” refers to a computational system, algorithm, or structured representation used with a ML system. Examples of models include ML models, neural networks, transformer-based architectures, generative models, reasoning models, agentic systems, probabilistic models, statistical models, or rule-based systems. Models may be designed to process input data and produce outputs, predictions, decisions, actions, representations, or generated content. Models may operate under various learning paradigms, including supervised, unsupervised, semi-supervised, reinforcement, or self-supervised learning, and may be configured to perform tasks such as classification, regression, recommendation, anomaly detection, generation, translation, summarization, planning, decision-making, or multi-step reasoning across a range of data modalities, including structured data, text, images, audio, video, and sensor data.

As described herein, a “tool” refers to a discrete, callable unit of functionality that is registered within a platform registry and made accessible to one or more subsystems of an application. A tool may encapsulate a particular software capability, module, or feature, and may be invoked directly by a user or indirectly by an orchestration engine, assistant subsystem, or agentic process. A tool may be defined by a metadata specification that describes its functional purpose, input parameters, output types, and access constraints. Such metadata may further include contextual invocation rules or skill-gating requirements that limit tool execution based on user roles, system state, or external conditions. A tool may also be executed within the host application or may trigger remote services, APIs, or external modules. For example, a tool may perform data transformation, retrieve content from a content management system, initiate ML inference, or apply an automation feature to a digital asset. Tools may be atomic (e.g., performing a single function) or composite (e.g., orchestrating multiple underlying functions).

As described herein, a “module” generally refers to a discrete, encapsulated software unit that implements a defined subset of functionality within a larger system. For example, a module may include executable code, data structures, and associated interfaces that collectively enable the module to perform one or more tasks, operations, or services. In some implementations, a module may expose an API or inter-process communication interfaces through which other system components (e.g., agents, tools, or orchestration engines) may invoke module functionality. The module may be configured for local execution within an application runtime or for remote execution via a distributed service environment.

As described herein, a “collection” generally refers to a structured data container defined within a content management system. A collection may include one or more fields specifying attribute types and constraints, where each field is configured to store content of a designated type (e.g., text, image, reference, or relational identifier). The collection may further define a schema for a class of content items and may be programmatically bound to presentation templates for automatic instantiation of one or more web pages or components.

As described herein, a “component” generally refers to a reusable design element or grouping of design elements within a visual design environment. A component may include structural markup (e.g., containers, text elements, media placeholders), style definitions (e.g., Cascading Style Sheets (CSS) class associations), and behavioral attributes (e.g., event listeners, animations). Components may be instantiated multiple times across different pages, with instances linked to a common definition such that modifications to the component definition propagate to each instance.

As described herein, a “schema” generally refers to a structured definition that specifies the organization, attributes, and relationships of data within a system. A schema may define one or more fields, each field associated with a data type (e.g., text, integer, media, or relational reference), a set of constraints (e.g., required, optional, uniqueness), and optionally a linkage to other schemas or data sources. The schema operates as a blueprint governing how data is stored, validated, and retrieved by the system. A schema may be represented in a machine-readable format (e.g., JavaScript Object Notation (JSON), Extensible Markup Language (XML), proprietary markup), enabling programmatic generation of data containers and enforcement of structural consistency across instances. At runtime, the system may validate input data against the schema to ensure compliance and may utilize the schema to automatically bind data values to

[symbol]

As used herein, a “template” generally refers to a parameterized layout structure defining a presentation format for one or more data-driven pages. A template comprises a set of design elements, placeholders, and binding definitions linking fields of a collection to corresponding elements of the layout. Upon execution of a publishing or rendering process, the template is programmatically combined with data from one or more collection items to generate fully populated output pages or views.

As used herein, “interactions” generally refer to declarative animation and behavior specifications that define dynamic changes to one or more elements of a rendered page in response to runtime events. An interaction may include a trigger definition identifying the initiating event, a set of target elements, and one or more animation or state-change operations to be applied to the target elements according to defined timing or sequencing parameters.

As used herein, a “trigger” generally refers to an event condition that initiates execution of an associated interaction or workflow. Triggers may include user-interface events (e.g., click, hover, scroll, page load) or system-generated events (e.g., content update, data submission). A trigger definition may specify the scope of the monitored condition and, upon detection of such condition, causes initiation of the corresponding action sequence.

As used herein, “logic” refers to a declarative workflow specification defining automated operations to be executed in response to system or user events. Logic may be represented as a sequence of interconnected nodes or steps, where each step specifies an action (e.g., data manipulation, API request, content update) and may include conditional branching, variable mapping, or external service integration. Logic is evaluated and executed by a backend workflow engine in response to event detection.

As described herein, an “agent” (or “ML agent”) generally refers to a software entity configured to operate autonomously or semi-autonomously within a computing environment by perceiving context, evaluating state, and executing one or more actions on behalf of a user or system. Agents may incorporate ML models (LLMs, LAMs), or other ML-based subsystems that enable adaptive behavior, natural language processing, decision-making, and dynamic invocation of system functionality.

Further, an “agentic” process or behavior generally refers to the autonomous or context-driven execution of actions by an agent, without requiring explicit step-by-step instructions from a user. For example, agentic functionality may include interpreting natural language or multimodal prompts based on processing input queries submitted by a user. In other examples, agentic functionality includes determining relevant goals or sub-tasks, invoking software capabilities (e.g., tools, functions, external services registered) within a platform registry, and sequencing or chaining such invocations until an objective is satisfied.

As discussed in detail below, the ML techniques disclosed herein may be provided to augment, streamline, and/or improve various aspects of a web experience platform that allows users to perform various types of actions relating to website development (e.g., access, design, develop, build, access, manage, analyze). Through use of ML, the techniques disclosed herein may allow users to generate website or webpage content that conforms to structure and schema of a designated webpage. For example, in a ML-enabled web experience platform, when a user requests for changes or modification to components of a webpage, the ML may be configured to create new text, images, and other relevant content based on the user text, prompt, selection, or other input provided by the client device.

Implementations of the present disclosure are described in further detail herein with reference to the creation of content for webpages. In some implementations, the techniques described in this present disclosure are applicable to the creation of content for other application, such as applications, emails, product designs, brochures, or other products, to name some examples.

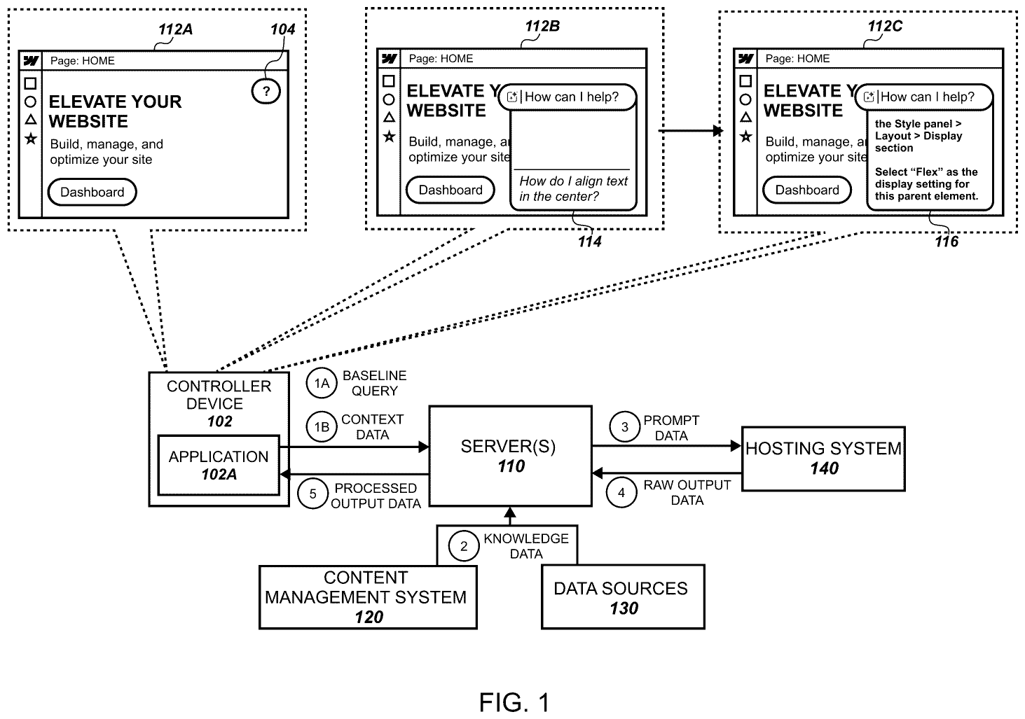

FIG. 1 illustrates an example of a technique for enabling ML-assisted guidance using RAG over a maintained knowledge base of a CMS. In the example shown, application 102A includes an ML interface (e.g., text-based chat interface) that is accessible through interaction with a UI element 104. This allows application 102A to incorporate a contextual assistant pipeline that aligns user-visible interface states with backend retrieval and inference operations.

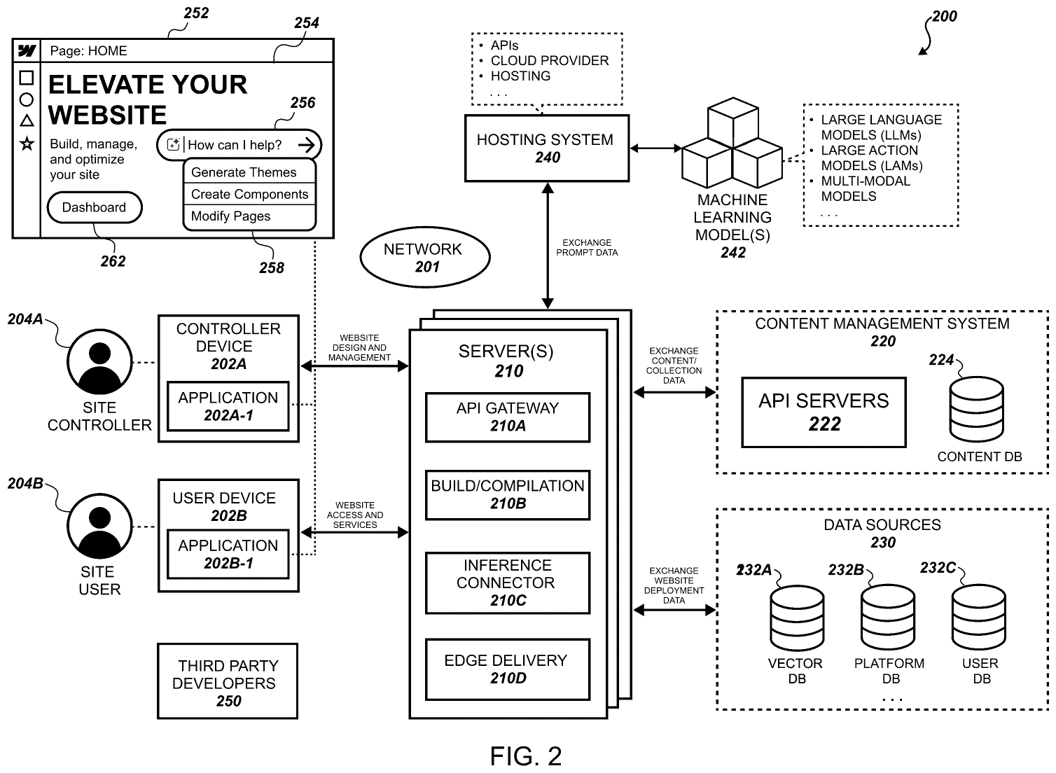

As shown near the top portion of FIG. 1, application 102A includes three interface states (112A, 112B, 112C) for enabling interactions with an ML interface through which a user may obtain information. This interaction is facilitated by data processes shown near the bottom portion of FIG. 1. Specifically, a controller device 102 and application 102A interact with server(s) 110 in enabling user access to application 102A. Application 102A may be part of a platform (e.g., the WEP shown in FIG. 2) that further includes one or more server(s) 110, content management system (CMS) 120, data sources 130, and hosting system 140. These elements implement backend processes (e.g., information retrieval, information refinement, prompt generation/submission, output processing, output refinement) relating to user actions on a software frontend and information presented responsive to these user actions.

For example, a user may ask a question relating to how to perform an operation in relation to a component that is configurable within an authoring environment of application 102A. In this example, the backend processes executed by the server(s) 110, the CMS 120, the data sources 130, and the hosting system 130 facilitate the retrieval of information responsive to the question, ensure that the retrieved information is relevant to each of the operation and the configurable component, and refines the presentation of the retrieved information is useful based on the workflow context associated with the application 102A when the user asked the question. In this way, retrieved information presented to the user is responsive (e.g., addresses the user's question), up-to-date (e.g., consistent with a knowledge base associated with an underlying CMS), and contextually-relevant (e.g., relevant to a workspace context associated with interface state). This improves the likelihood that a user perceives the output as useful and/or useable.

In the example shown in FIG. 1, in a first state 112A, an authoring interface displays UI element 104 and standard design controls. The UI element 104 functions as an affordance that, when interacted with (e.g., clicked on), provides access to a chat panel 114 in a second state 112B. In this state, a user submits a baseline query represented as a text input stating a question (“How do I align text in the center?”). In the third state 112C, application 120A presents an in-context instruction 116 that informs the user where to act within the authoring environment (e.g., by navigating to a specific style panel path). As shown in the figure, the progression between the three states allows the user to receive an output within the same authoring environment without switching tools or leaving the canvas.

As to backend processes, controller device 102 enables access to the application 102A based on communications with one or more server(s) 110. For example, application 102A may be an application that is hosted on the server(s) 110 and accessed on application 102A through a software client (e.g., web browser, native application).

At step (1A), application 102A transmits baseline query data captured from the chat panel 114. As step (1B), application 102A also provides context data that describes aspects of the workspace accessed by the user (e.g., active page, selected elements, component hierarchy, recent authoring actions). These inputs allow the server(s) 110 to determine a workspace context corresponding to the baseline query.

The server(s) 110 receives the baseline query and context data and generates a refined query that is adapted and/or conditioned based on the workspace context. At step (2), the server(s) 110 access knowledge data from CMS 120 and data sources 130, which collectively identify a corpus of relevant documents (e.g., documents specifying tutorials, best practices, product references) for retrieval. The server(s) 110 also identify content chunks that are semantically relevant to the refined query, which enable identification of corresponding vector representations within one or more vector databases (not separately shown but included in the data sources 130). This ensures that retrieved content information includes up-to-date information relating to the component referenced in the baseline query maintained within the CMS 120.

At step (3), the server(s) 110 generate prompt data for downstream model execution using the refined query and retrieved vector representations. The prompt data may specify instructions for generating text-based outputs, including identification of the semantic content associated with the content chunks identified in step (2), instructions for adapting generated text based on previously generated text, or other related information for further refining text generation. At step (4), the hosting system 140 receives prompt data and executes one or more ML models 142 to produce output data. The output data is returned to the server(s) 110 for further processing. At step (5), the server(s) 110 process the output data to generate processed output data in a format that is suitable for presentation within application 102A.

The processed output data may specify one or more instructions that, when received by application 102A, causes the authoring environment of application 102A to present an in-context response 116 (with an ML-generated answer and/or guidance) within the authoring environment. As shown in FIG. 1, the in-context response 116 is displayed in interface state 112C. Instructions specified in the in-context response 116 may reference, for instance, specific panels, fields, or element settings so that the user may immediately perform the recommended action without navigating away from the current task.

The information retrieval techniques shown in FIG. 1 improve upon RAG-based pipelines involving static vector databases. ML systems that rely on such RAG-based pipelines typically embed free-form documents without regard to application schemas. Similarly, some CMS platforms typically store typed records without generating embeddings that preserve referential constraints or field semantics. In contrast, the techniques shown in FIG. 1 involve generating schema-aware content chunks and corresponding vector representations that explicitly preserve CMS configurations and limitations. Chunk boundaries and embedding metadata are aligned to collection schemas, field types, and cross-reference links (e.g., component IDs, locale variants, or gated fields) so that retrieved content may be injected into prompts and rendered back into the authoring environment without violating referential integrity.

This schema alignment discussed above improves performance in two ways. For instance, it increases retrieval precision by ensuring preference over chunks whose schema tags match the workspace context of application 102A. Further, it reduces post-retrieval repair work because the output data from the ML models 142 is constrained to data models specified by the CMS 120. This is distinct from implementing a standard RAG index with a CMS, which does not involve specific types of chunking and embedding that preserve field-level typing, relationship graphs, and policy constraints.

Moreover, RAG pipelines also tend to produce static indexes (e.g., embeddings computed once and reused until a full rebuild). Similarly, CMS platforms update content continuously without coordinating vector freshness. The system and techniques described within this disclosure address this capacity gap with a recursive, CMS-driven update loop that re-embeds only the affected chunks when schemas, features, or referenced records change, and advances version pointers so retrieval prefers up-to-date vectors.

In some implementations, CMS events (e.g., content publish, schema edit, feature flag change) trigger dependency resolution that identifies impacted chunks, recalculates embeddings, and atomically swaps index entries so the vector database reflects the current configuration without a global reindex. This architecture addresses a known limitation of static RAG that answers that are accurate to their source but outdated or misaligned to a user's current configuration. As shown in FIG. 1, by ensuring that similarity searches are performed over a living corpus whose semantics track the CMS 120, the resulting benefits are improved contextual relevance and improved responsiveness.

The interplay between schema-aware embeddings and the recursive CMS updates also yield various advantages at runtime. For instance, because vectors carry schema and version tags, the server(s) 110 may condition query refinement on the workspace context and select only those chunks whose schema/version signatures match the user's workspace context. This reduces false positives that some RAG systems would surface. Conversely, as the CMS 120 evolves (e.g., a component API changes), update loops ensure the same signatures steer retrieval away from superseded guidance without requiring manual curation. This closed-loop behavior informs how the server(s) 110 orchestrates retrieval and prompting under latency constraints and at multi-tenant scale. This behavior also depends on specific types of data transformations and index maintenance strategies that are specific to typed, evolving application schemas and their operational event streams.

FIG. 2 illustrates an example of a system 200 enabling a web experience platform (WEP) for enabling website development using one or more ML models. In general, the website development capabilities enable users to design digital experiences, ingest user-defined digital experience specifications, transform the user-defined digital experience specifications into deployable artifacts, and distribute resulting web experiences over a network. For example, the WEP may receive design-time input that specifies pages, components, styles, interactions, and content, compile or otherwise process that input (e.g., assistance from one or more ML models) into executable markup, code bundles, media, and metadata. The WEP may store intermediate and final artifacts in multi-tenant data stores, identify published experience and associated application services to site visitors with edge-based delivery resources. This environment may further support content management, e-commerce, membership gating, localization, extension APIs, among other types of functionality.

In general, system 200 leverages ML within a content-management, schema-constrained WEP to address computer-centric problems in generating, selecting, and rendering webpage modifications at scale. System 200 obtains structured inputs defined by a content schema and associated metadata (e.g., section-level or hierarchy information), constructs constrained prompt data or model inputs from those structures, and applies trained ML models to produce candidate outputs that are validated for structural compatibility before use in the build and delivery pipeline. By grounding ML operations in machine-readable constraints and executing only schema-compatible results, system 200 improves computer operation in distributed web systems (e.g., by reducing integration failures, avoiding incompatible markup, limiting unnecessary network transfers, and enabling low-latency rendering of a single, selected variant on the client device). The WEP further augments and/or improves various aspects of the web development functionality through use of one or more ML models 242. These ML models 242 may be invoked at multiple, independent junctures of WEP workflows to streamline, accelerate, and/or augment tasks that have traditionally needed manual development effort.

For example, a site controller operating the controller device 202A may access an ML interface 256 (e.g., presented as a text-chat, voice, or multimodal panel within the existing design canvas) to submit natural language prompts that cause the one or more ML models 242 to generate entire page layouts, reusable components, helper functions, and the corresponding markup or code artefacts without leaving an authoring environment. After a site has been deployed, other ML interfaces may be used to request automated regeneration or modification of components in a manner that preserves data bindings and collection schemas maintained by a content management system (CMS) 220. This reduces the risk of breaking existing CMS-driven pages.

In another example, a site controller 204A or site user 204B administrator may invoke an ML assistant exposed through a dashboard widget to obtain step-by-step guidance on operational tasks (e.g., configuring localization variants, setting up gated-membership rules, or troubleshooting performance settings) based on conversational queries rather than navigating multiple configuration panels. Each of these interfaces may simply route prompt data to external model resources (e.g., hosting system 240) and returns model output to the same front-end context, the ML functionality may be layered onto different phases of the website-development lifecycle without requiring structural changes to the underlying build, orchestration, or delivery services.

The WEP includes various computing and data elements, examples of which are shown in FIG. 2. These elements generally exchange data over network 201. Controller device 202A represents an authoring endpoint operated by a site controller. User device 202B represents a consumption endpoint operated by a site user. Additional third-party developer devices 250 may interact with extension tooling.

One or more server(s) 210 enable centralized functionality associated with the WEP. These server(s) 210 may correspond to the server 122 shown in FIG. 1. As such, server 122 may perform the functionality described with respect to server(s) 210. Server(s) 210 further include API gateways 210A, orchestration modules 210B, build/compilation modules 210C, inference connector modules 210D, and edge-delivery modules 210E, each of which cooperate to perform request handling, background workflow, artifact generation, machine-learning integration, and content delivery network (CDN)-style dissemination, respectively. CMS 220 encloses API servers 230 and a content database 212B. Further, data sources 230 includes persistent stores, such as vector database 232A, platform database 232B, user DB 232C. A hosting system 240 exchanges prompt data and model output with one or more ML models 242.

In more detail, the site controller 204A may operate a controller device 202A (e.g., desktop computer, laptop, tablet, or similarly capable computing terminal). The controller device 202A executes an authoring application 202A-1 that communicates with WEP over network 201. Using the authoring application 202A-1, the site controller may generate, import, or modify design-time assets (e.g., page structures, component libraries, style sheets, interaction timelines, and data bindings) and submit corresponding save, build, or publish requests to server(s) 210. Controller device 202A may render the authoring application in a browser context, a native container, or another runtime environment, and may exchange design-and-or-maintain website-deployment data with the platform in real time or near-real time.

A site user 204B may operate a user device 202B (e.g., desktop computer, laptop, tablet, smartphone, set-top box) executing a runtime application 202B-1 that requests and renders published site assets delivered by server(s) 210. The user device 202B may load static pages, dynamic CMS-backed content, e-commerce flows, membership-gated resources, or localized variants, depending on how the site was configured by the controller. Interactions initiated from the user device 202B may result in access-and-or-interact website-deployment data being exchanged with server(s) 210, with optional personalization, authentication, or analytics processing performed along the way.

As shown in FIG. 2, the authoring application 202A-1 presents a designer interface 252 that provides access to visual tools enabling a site controller 204A to construct and/or alter a page 254 without direct manipulation of source code. Within interface 252 a component pane may surface reusable elements such as component 262, and a canvas or viewport may preview the evolving layout in real time. An ML interface 256 permits the site controller 204A to issue natural language prompts or other inputs to interact with one or more models 242 via hosting system 240. Interface 256 may be implemented in various ways, such as a chat panel, voice overlay, multimodal widget, among others. Responsive model output may drive ML-assisted functions 258, which may include, for example, automatically generating page sections, refactoring existing component 262 for accessibility or localization, producing CMS-compatible schema suggestions, or inserting client-side logic templates. Depending on configuration, similar ML interfaces may also surface within runtime application 202B-1, allowing site users to obtain guided assistance or perform management tasks through conversational interaction.

Server(s) 210 operate as the execution core of WEP, receiving network traffic from external actor devices, coordinating internal workflows, invoking machine-learning resources, and emitting deployable or runtime assets. Although depicted as a single logical block, server(s) 210 may be implemented as a co-located cluster, a distributed micro-service mesh, or a cloud-hosted arrangement that scales elastically with demand.

Further, server(s) 210 incorporate a set of software modules configured to cooperate through message queues, RPC calls, or other service-bus mechanisms. At a high-level API gateway modules 210A handle synchronous ingress. An orchestration tier (not shown in FIG. 2) manages background or long-running tasks. Build/compilation modules 210B convert design input into deployable artifacts. An inference connector layer 210C broker prompt exchange with the hosting system 240. Edge delivery modules 210D stage static and dynamic resources for low-latency distribution. Each module may be containerized, serverless, or otherwise independently deployable, allowing updates to be rolled out without interrupting the WEP.

API gateway modules 210A perform various functions, such as terminating Transport Layer Security (TLS), validating JavaScript Object Notation (JSON) Web Tokens, and expose Representative State Transfer (REST), Graphical Query Language (GraphQL), or WebSocket interfaces that client applications call when saving designs, fetching CMS content, or running administrative queries. They may apply per-workspace or per-site rate limits, translate external resource identifiers into internal shard keys, and inject correlation metadata into each request for downstream tracing. In zero-trust configurations, the API gateway modules 210A may also perform mutual-TLS handshakes with edge nodes or developer command line interfaces (CLIs) before forwarding traffic onto the internal mesh.

Build/compilation modules 210B retrieve development snapshots, CMS bindings, and theme settings, and emit hashed asset bundles, pre-optimized image variants, framework-specific component libraries, and search-index manifests. A dependency graph may be used to identify pages or assets are invalidated by a change so that a full rebuild is avoided. Unchanged artifacts may also be linked from previous build versions. Output objects are written to a versioned S3-style bucket, tagged with a content hash and build-number metadata, and handed off to edge-delivery modules for global propagation.

Inference connector modules 210C assemble prompt payloads that may include design fragments, content snippets, schema fingerprints, and user-authored questions. The inference connector modules 210C may sign each request with a per-workspace API key, apply temperature or max-token policies set by workspace administrators, and/or dispatch prompts to an external model endpoint over authenticated (e.g., HTTP/2) channels. Inference connector modules 210C also parse received model output into typed actions, such as “generate component,” “rewrite copy,” or “suggest accessibility fix.” These parsed outputs may be queued back to orchestration modules or streamed directly to user devices.

Edge delivery modules 210D take artifacts produced by the build/compilation modules 210B and replicate them across geographically distributed points of presence. Assets may be version-pinned so a canary rollout may serve the new build to a percentage of traffic while the prior build remains active for the remainder. Edge workers may also execute JavaScript or WebAssembly to perform request-time tasks—e.g., cookie-based A/B routing, on-the-fly image resizing, or server-side rendering of personalized fragments before returning a response that is cached for subsequent requests.

The architecture of server(s) 210 enable various applications of ML models 242 in relation to different web development workflows accessible through the WEP. In some implementations, server(s) 210 enable an authoring workflow in which a newly added component is propagated from the design canvas to production in near real-time. For example, when a controller drags a “testimonial” component onto the canvas, the interface 252 emits a JSON delta via WebSocket to API-gateway modules 210A. Orchestration modules enqueue a build job, and the build/compilation modules 210B regenerate only the affected page bundle while reusing shared CSS and runtime libraries. Inference connector modules 210C send the component copy to ML models 242 (e.g., LLM) and requests tone-consistent rewrites. Model output data may be streamed back to the interface 252 for user review and approval. The edge delivery modules 210D pre-warm caches for the updated path, enabling publishing to be completed quickly (e.g., under a second).

In some implementations, server(s) 210 enable a live component-refactor workflow that automates accessibility or structural updates across an existing site. A site controller 204A may type “convert nav bars to an accessible drop-down” into ML interface 256. In response, inference connector modules 210C package a prompt containing the site's navigation markup and audit results, retrieve refactored HTML and a, and forward the patch to build-and-compilation modules 210B. After incremental compilation, edge-delivery modules 210D push the new build while invalidating only nav-bar assets. A rollback pointer to the previous build is retained for instant reversion if post-publish tests fail.

In some implementations, server(s) 210 enable an administrative guidance workflow that delivers conversational, ML-generated instructions for platform configuration tasks. For example, a site user 204B may interact with a voice widget to ask, “How do I enable multi-language support?” In this example, a voice clip may be transcribed on the user device 202B and posted to API-gateway modules 210A. Inference connector modules 210C query one or more ML models 242 (e.g., knowledge base aware model) that returns a checklist of localization steps plus one-click mutation calls. Orchestration modules create a location workspace, build/compilation modules 210B obtain locale variants, and edge delivery modules 210D begin serving Accept-Language aware routes. This workflow allows the task to be completed without manual navigation through multiple settings screens.

CMS 120 manages structured content that populates pages, components, and dynamic lists served by WEP. The system lets a site controller define collections, fields, and localized variants, stores and surfaces that content so that build and runtime processes may merge it with design artifacts. During ML workflows prompts may be enriched with relevant collection entries or schema information. Model output may be validated against the same schema to ensure that any generated markup stays coordinated with stored data.

CMS 220 further includes API servers 222 and content database 224. The API servers 222 expose read and write endpoints that the design canvas, build pipeline, and runtime site all consume. The content database 224 stores collection items, draft, locale variants, and reference links (e.g., in a multi-tenant partition so that different workspaces remain isolated). These elements of CMS 220 let other modules in WEP (e.g., modules of server(s) 210) treat content as a typed data source rather than raw text.

API servers 222 may implement REST and GraphQL methods for creating collections, uploading media, managing localization, and querying entries at build or request time. Requests enter through API gateway modules 210A and are routed to the appropriate microservice shard. Each call is checked against workspace roles so that only authorized users or processes may insert or mutate content. Server(s) 210 also transmit events that orchestration modules may listen to trigger incremental rebuilds or cache purges.

Content database 224 is a multi-region document store that persists collection schemas, field values, slug indexes, and locale mappings. Each write operation may be versioned, allowing rollback if a site controller 204A accidentally deletes or changes an entry. The content database 224 supports full-text and faceted search so that runtime pages may query on reference fields without loading entire collections. It also stores media metadata that edge delivery modules 210D may use for responsive image selection.

Interaction between API servers 222 and content database 224 may follow a strict commit path. For example, API servers 222 validate incoming payloads against collection schemas, transform the payloads into storage records, and write them to content database 224 in a transaction that ensures referential integrity. When data changes the servers publish a change event to orchestration modules. Build/compilation modules 210B may pull the updated entries, regenerate only the affected pages, and write new artifacts to the build repository. Edge delivery modules 210D receive a signed cache bust instruction so that users see the updated content without delay. This communication loop ensures design, content, and deployment states are aligned even when ML models generate or modify content through the same APIs.

Data sources 230 provide a storage layer that underpins content retrieval, ML context, and runtime personalization for WEP. Databases included in the database sources 230 may sit outside the server(s) 210 so it may scale storage capacity independently of compute demand. For example, read and write operations flow through API gateway 210A or orchestration tasks, and change events propagate to build or edge services so that newly stored records appear in published sites without manual intervention. During prompt generation, the inference connector 210C enriches requests with context fetched from these stores, and after model inference, the same stores are updated or queried to confirm that generated output aligns with existing schemas.

Vector database 232A stores high-dimensional embeddings that represent component code snippets, CMS entries, design tokens, and knowledge base documents. The vector database 232A supports approximate nearest-neighbor search so the inference connector may retrieve semantically similar records in milliseconds. Embeddings are regenerated during build or on demand when a large batch of content changes. The store also tracks embedding versions so model prompts always receive context that matches the active design or content revision.

Platform database 232B holds project metadata such as workspace settings, build history, billing status, feature flags, and role assignments. Each workspace or site occupies a logical partition that isolates records while still allowing cross-workspace queries for administrative analytics. The database maintains foreign keys to build artifacts in object storage and to content items in CMS 220, which lets server modules assemble a complete view of a project without performing fan-out requests.

User database 232C records site member accounts, authentication tokens, membership tiers, and e-commerce order history. Access tokens generated by API gateway 210A map to rows in this store, allowing edge delivery modules 210D to evaluate gating rules during request processing. The user database 232C also captures engagement metrics such as last login time or page view counts, which may feed personalization or analytics dashboards.

The databases discussed above operate together through shared identifiers and event streams to maintain consistency across the platform. When a controller publishes a new collection item the CMS writes the entry to content database 224 and emits an event that triggers embedding generation in vector database 232A. The same event updates index pointers in platform database 232B so build modules may link the updated content to its deployment record. If the item is member-restricted, a policy pointer is stored in user database 232C so edge delivery modules may enforce access at request time. This coordinated flow ensures that ML prompts receive up-to-date context, model output respects schema constraints, and published pages honor all access and personalization rules.

Hosting system 240 provides a managed inference service that receives prompt data from server modules and returns machine generated output used to augment website design, build, and runtime tasks. The hosting system 240 may allocate compute resources, schedule model workloads, enforce request quotas, and logs usage metrics. Prompt requests may include design fragments, CMS records, or visitor questions. Response payloads may contain generated code snippets, rewritten copy, layout suggestions, or operational guidance that the platform may apply without manual intervention.

Hosting system 240 integrates with the WEP through a set of network accessible endpoints that may be reached by direct API calls, by cloud provider private links, or by a customer managed hosting arrangement. The inference connector 210C authenticates each request with an API key, signs payloads, and posts them to an endpoint path that selects a specific model or model version. The hosting system 240 may reside in a public cloud region, in a dedicated tenancy, or in an on-premise cluster that meets data residency requirements. Configuration flags allow workspace administrators to choose among these connectivity modes without changing application code.

ML models 242 implement the inference logic that generates the information used by the WEP. The models may be large language models (LLMs) that excel at natural language generation, large action models (LAMs) that plan multi step tasks, or multimodal (MM) models that accept and emit combinations of text, code, or image embeddings. Each model may be versioned and measured for token usage, latency, and accuracy. The hosting system 240 may route traffic to a single model or to an ensemble of models depending on the prompt type and workspace policy.

ML models 242 operate inside the hosting system 240 in containerized runtimes, e.g., runtimes that that expose uniform gRPC and REST interfaces. The hosting layer may handle model loading, weights decryption, warm-up sequences, and autoscaling. It also injects guardrail middleware that checks prompts for policy compliance and truncates or redacts disallowed content. Model output is streamed back to system 200 in an event format that preserves token order so the authoring canvas may display partial completions in real time.

As discussed above, the system 200 may be designed in various implementations to augment, improve, or streamline various aspects of website development using interactions with the one or more ML models 242. For example, a site controller 204A may access interface 252 on controller device 202A and enter a natural language prompt into ML interface 256 asking the platform to “generate a five-page marketing site for a coffee brand with warm colors and bold headings.” Application 202A-1 sends the prompt to API gateway modules 210A over network 201. Inference connector modules 210C forward the prompt to hosting system 240 which relays it to ML models 242. The ML models 242 return structured markup and component definitions that reference images and copy aligned with the request. Build/compilation modules 210B merge the generated markup with schema information pulled from content database 224 through API servers 222 so that every collection reference is valid. Edge delivery modules 210D publish the new artifacts and invalidate only the changed routes which lets user devices 202B immediately load the freshly created pages.

As another example, a site controller 204A may decide to localize the site for Spanish speaking visitors using the same workflow. The site controller 204A issues a prompt in interface 256 that requests translated versions of each collection item stored in content management system 220. API gateway modules 210A receive the prompt along with collection identifiers. Inference connector modules 210C assemble context by fetching the English records and related embeddings from vector database 232A pass that context to ML models 242. The ML models 242 return translated field values which API servers 222 write as new locale variants in content database 224 while platform database 232B records a build dependency for each updated item. Build/compilation modules 210B regenerate only the localized bundles and edge delivery modules 210D tag them with Accept-Language rules so site users automatically receive the correct language version.

In yet another example, during ongoing operation a site user 204B signs in through application 202B-1 and asks an on-page chatbot how to schedule a product launch for next Friday. The question travels through network 201 to API gateway modules 210A and is passed to inference connector modules 210C with user context from user database 232C. ML models 242 analyze the prompt and return a step list that includes creating a draft collection item, assigning a release date, and triggering a publish event. The response also contains signed mutation requests that API servers 222 may execute on behalf of the authenticated user. Orchestration logic writes the new item to content database 224, schedules a timed build in platform database 232B, and notifies build and compilation modules 210B to pre render the page. Edge delivery modules 210D queue a cache purge for the launch path so the updated content appears exactly when the scheduled date arrives.

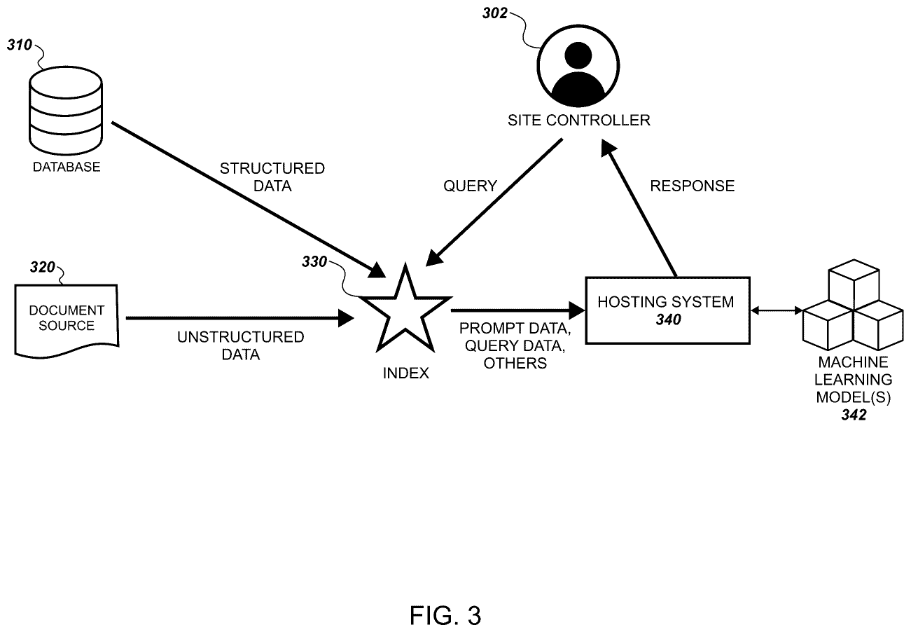

FIG. 3 illustrates an example of an architecture for using retrieval-augmented generation to retrieve contextually relevant information from a content management system. In this example, content generation involves a data pipeline in which heterogeneous source content is indexed and used to answer a site controller's query with machine-generated guidance.

As shown, a database 310 provides structured data, a document source 320 provides unstructured data, and an index 330 consolidates these inputs for retrieval. A site controller 302 issues a query that the system resolves by producing prompt data, query data, and other context from the index 330 and forwarding them to a hosting system 340. The hosting system 340 executes one or more ML models 342 and returns a response to the site controller 302.

The database 310 represents structured sources such as curated tutorials, component catalogs, API references, and best-practice checklists maintained under schema control. Records are read and normalized, mapped into fields suitable for retrieval features such as titles, headings, anchors, tags, and freshness metadata. For semantic search, each record is segmented into content units and embedded to generate vector representations that the index 330 may use during retrieval. The index 330 stores keys that link each vector to its originating record so that answers may cite authoritative passages. In some implementations, the plurality of vector representations correspond to content chunks segmented from a multimodal knowledge base of web design concepts. Each chunk may carry modality tags and version identifiers so that the retriever may prefer current, authoritative material during query time.

The document source 320 includes unstructured data specified in different file formats (e.g., PDF documents, HTML pages, design notes, support articles, video transcripts). Incoming files are parsed, cleaned, and transformed into canonical text spans. A chunking routine applies size limits and semantic boundaries so that each span preserves local coherence and may stand alone in a prompt. The resulting spans are embedded, and their vectors are added to the index 330 alongside vectors derived from structured records. Incremental update logic further allows new or modified documents to be inserted without reprocessing the entire corpus.

In some implementations, content is accessed from a multi-modal knowledge base maintained within a CMS platform (e.g., CMS 120) and segmented into a plurality of content chunks. Boundary conditions may include maximum token counts, heading boundaries, caption cues, and modality transitions to retain meaning across chunks. Boundary conditions may be identified by calculating a semantic similarity score between adjacent text segments and determining that the score satisfies a predetermined semantic similarity threshold. Segments with high similarity may be merged to avoid over-fragmentation, while dissimilar segments define hard boundaries that prevent topic drift in retrieval.

The index 330 maintains retrieval structures spanning both structured and unstructured sources. When the site controller 302 issues a query, the system may enrich it with context (e.g., project type, active elements, and recent actions) and produce a refined query that better aligns with a user's request. The index 330 resolves the refined query by performing semantic search over stored vectors and, when useful, combining similarity scores with lexical or freshness signals. Top-ranked vectors and their linked passages are packaged as prompt data, query data, and other context data for downstream inference by the hosting system 340.

The hosting system 340 receives packaged prompt data and invokes one or more ML models 342 to generate output data (e.g., answer to a question specified in a baseline query). For example, one or more ML models 342 may synthesize retrieved passages with the refined query and produce a response tailored to the site controller's task. Upon further processing by server(s) 119, a response is provided to the site controller 302, which may be rendered in a chat panel or as in-context annotations that direct the user to specific controls or panel paths.

In some implementations, the one or more ML models 342 include LLMs and/or LAMs. In such implementations, the LLMs may be combined with tool use policies that format answers as actionable steps. Routing may select among different model versions or ensembles based on prompt type, workspace policy, or latency budget.

The system may also enforce an end-to-end latency target measured from receipt of the baseline query to presentation of the response, with the time period constrained to be less than a predetermined threshold. In such implementations, the predetermined time threshold may be associated with the RAG configuration associated with the index 330. The predetermined time threshold may be specified based on specific implementation demands associated with information retrieval (e.g., within one second, within two to five seconds). The system may be implemented to satisfy these demands by, for instance, caching frequent embeddings, precomputing index features, using approximate nearest-neighbor search for vector lookups, co-locating the hosting system 340 with the index 330 to minimize network hops, among others.

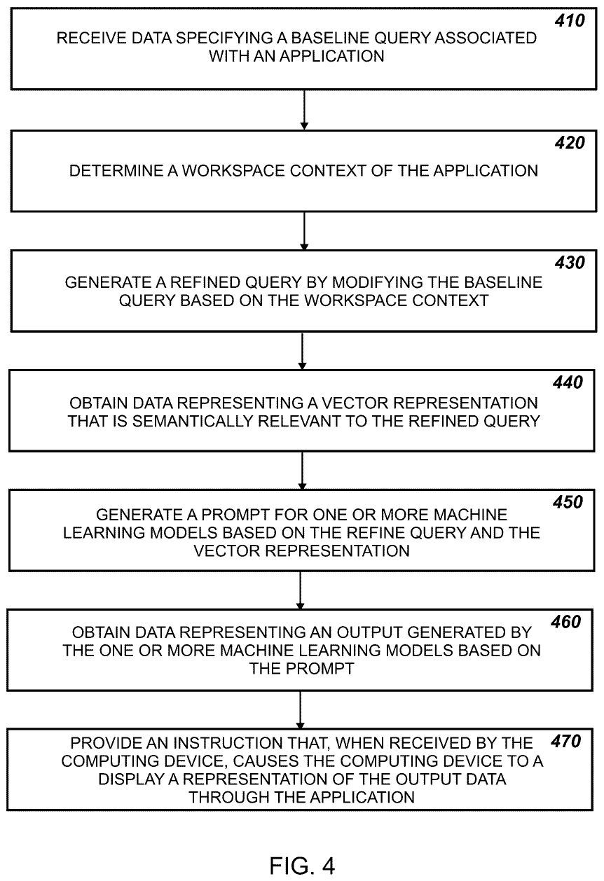

FIG. 4 is a flow diagram of an example process 400 executed by server(s) 110 to deliver context-aware guidance within an application 102A using retrieval-augmented generation over knowledge maintained in a content management system 120. The process 400 may be executed by elements of system 200 and in relation to the technique shown in FIG. 1. For example, application 102A on controller device 102 transmits a baseline query (step 1A) captured from chat interface 114 and context data (step 1B) describing the workspace context. The server(s) 110 refine the baseline query using that workspace context and retrieve semantically relevant vector representations from data sources 130 using knowledge data provided by CMS 120 (step (2). The server(s) assemble prompt data for a hosting system 140 that executes one or more ML models (step (3)). Raw output data is returned to the server(s) 110 (step (4)). Based on further processing, the server(s) 110 produce processed output data that instructs the application 102A to render an in-context response 116 within interface state 112C (step (5)).

In more detail, process 400 includes receiving data specifying a baseline query associated with an application (410). For example, a user enters a question in a chat interface 114 of the application 102A on a controller device 102, and the application 102A transmits the baseline query to server(s) 110 as baseline query data over a network. As shown in FIG. 1, the baseline query is a natural language text (“How do I align text in the center?”). The receiving endpoint on the server(s) 110 may validate authentication, normalize the text, and record the event for conversation threading. In some cases, application 102A also provides lightweight hints about the active view 112A so the server(s) 110 may associate the query with the correct workspace.

In some implementations, the baseline query is provided at a first time in relation to a graphical user interface of the application, and the workspace context includes one or more design elements displayed on the graphical user interface at the first time. The GUI may include a canvas and style panels presented in state 112A, and the transmitted payload may reference the selected node identifiers that were visible when the query was sent through the chat interface 114.

Process 400 includes determining a workspace context of the application corresponding to the baseline query (420). For example, the server(s) 110 correlate the query with application state signals provided as context data (e.g., active page, selected components, breakpoints, recent editing actions) captured by the application 102A. The server(s) 110 may classify the user's skill level based on historical interactions to tailor guidance for novice or expert modes. Context derivation may include redaction rules to avoid collecting sensitive content while still preserving useful structural information. The resulting context object is associated with the baseline query for downstream retrieval and prompting.

In some implementations, the workspace context specifies a project type of a web application that is accessed through the application at the first time. Project type may include labels such as “marketing site,” “e-commerce,” or “documentation,” and this label may influence retrieval priorities and phrasing of the response rendered in state 112C.

Process 400 includes generating a refined query by modifying the baseline query based on the workspace context (430). For example, the server(s) 110 expand the baseline query with design vocabulary drawn from the context data, disambiguate element names, and include the project type to focus retrieval. A gating stage may determine whether the question is answerable from the maintained knowledge base within CMS 120 before proceeding. The refined query is formatted for compatibility with a retriever and retains a link to the originating conversation thread opened in interface 114. The refinement step improves alignment of retrieved material with the user's immediate task.

Process 400 includes obtaining data representing a vector representation that is semantically relevant to the refined query (440). For example, the server(s) 110 perform semantic search against one or more vector databases included within data sources 130 that store embeddings for a plurality of candidate passages derived from knowledge data. Candidate vectors are ranked by similarity to the refined query, optionally combined with freshness and authority scores maintained by CMS 120. The selected vectors reference underlying content chunks drawn from curated tutorials, best-practice guides, and product references. The result is a small set of vectors and pointers suitable for prompt construction.

In some implementations, the plurality of vector representations correspond to content chunks segmented from a multi-modal knowledge base of web design concepts maintained within CMS 120 and exposed to the server(s) 110 as knowledge data. The chunks may originate from text documents, video transcripts, or interactive tutorials that are prepared for retrieval and stored in vector databases within data sources 130.

The process 400 may further include accessing content specified by a multi-modal knowledge base within a content management system 120 associated with the application 102A, identifying a set of boundary conditions for that content, and segmenting the content into a plurality of content chunks. Boundary conditions may include maximum token count, section headings, caption markers, and modality tags that preserve meaning during retrieval, and the resulting chunks are embedded and written to the vector stores in data sources 130.

In some implementations, identifying the set of boundary conditions includes calculating a semantic similarity score between a first text segment and a second text segment within the knowledge base managed by CMS 120 and determining that the score satisfies a predetermined semantic similarity threshold. Adjacent segments that exceed the threshold may be merged to maintain coherence, while low-similarity boundaries are preserved to avoid diluting context before embeddings are stored in data sources 130.

The process 400 includes generating a prompt for one or more ML models based on the refined query and the vector representation (450). For example, the server(s) 110 assemble a structured prompt that contains the refined query, selected excerpts referenced by the retrieved vectors, and the workspace context. The prompt data may include instructions to cite sources, to propose step-by-step actions, and to avoid suggestions that conflict with the detected project type. Conversation history from the prior states may also be appended to maintain multi-turn coherence. The prompt is transmitted to a hosting system 140 as prompt data for inference.

In some implementations, the one or more ML learning models used in step 450 include an LLM executed in the hosting system 140. In such implementations, server(s) 110 may route traffic to a single LLM or an ensemble, with model selection governed by a workspace policy associated with application 102A.

Process 400 includes obtaining data representing an output generated by one or more ML models based on the prompt (460). For example, the hosting system 140 returns raw output data that explains the requested operation, along with optional action candidates and citations to the knowledge base. The server(s) 110 may parse the model output into typed instructions and evaluate them against safety and policy rules maintained for the workspace. If the retrieved context from knowledge data is insufficient, a fallback policy may request clarification from the user through the chat interface 114 or switch to a more general answer mode. The accepted output is formatted for presentation to the application 102A.

Process 400 includes providing an instruction that, when received by the computing device, causes the computing device to display a representation of the output data through the application (470). For example, the server(s) 110 return processed output data that the application 102A renders as an in-context message 116 within the authoring interface. This enables the user to act without leaving the canvas in state 112C. The instruction may include UI annotations, links to documentation stored in CMS 120, or one-click actions when permitted by workspace policy. The rendering completes the end-to-end loop that ties the user's query to a retrieval-grounded answer.

In some implementations, the data specifying the baseline query is received by the server(s) 110 at a first time point, the instruction that causes the computing device to display the representation of the output data is provided by the server(s) 110 at a second time point, and a time period between the first and second time points is less than a predetermined time threshold. Latency is measured from receipt of baseline query data to the moment processed output data is issued to the application 102A.

In some implementations, the predetermined time threshold is three seconds. The platform may enforce this target by caching common embeddings in data sources 130, reusing conversation state associated with the chat interface 114, and optimizing routing between the server(s) 110 and hosting system 140 so that typical interactions complete within the threshold and render guidance 116 within state 112C.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification may be realized in digital electronic circuitry, in tangibly-embodied computer software or firmware, in computer hardware, including the structures disclosed in this specification and their structural equivalents, or in combinations of one or more of them. Implementations of the subject matter described in this specification may be implemented as one or more computer programs (e.g., one or more modules of computer program instructions) encoded on a tangible non-transitory storage medium for execution by, or to control the operation of, data processing apparatus. The computer storage medium may be a machine-readable storage device, a machine-readable storage substrate, a random or serial access memory device, or a combination of one or more of them. The program instructions may be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus may also be, or further include, special purpose logic circuitry (e.g., an FPGA (field programmable gate array) or an ASIC (application-specific integrated circuit)). The apparatus may optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, may be written in any form of programming language, including compiled or interpreted languages, or declarative or procedural languages; and it may be deployed in any form, including as a stand-alone program or as a module, component, subroutine, or other unit suitable for use in a computing environment. A program may, but need not, correspond to a file in a file system. A program may be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines may be installed and running on the same computer or computers.

The processes and logic flows described in this specification may be performed by one or more programmable computers executing one or more computer programs to perform functions by operating on input data and generating output. The processes and logic flows may also be performed by special purpose logic circuitry (e.g., a FPGA, an ASIC), or by a combination of special purpose logic circuitry and one or more programmed computers.

Computers suitable for the execution of a computer program may be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory may be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media, and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification may be provisioned on a computer having a display device (e.g., a CRT (cathode ray tube) or LCD (liquid crystal display) monitor) for displaying information to the user and a keyboard and a pointing device (e.g., a mouse, a trackball), by which the user may provide input to the computer. Other kinds of devices may be used to provide for interaction with a user as well; for example, feedback provided to the user may be any form of sensory feedback (e.g., visual feedback, auditory feedback, tactile feedback); and input from the user may be received in any form, including acoustic, speech, or tactile input. In addition, a computer may interact with a user by sending documents to and receiving documents from a device that is used by the user; for example, by sending web pages to a web browser on a user's device in response to requests received from the web browser. Also, a computer may interact with a user by sending text messages or other forms of message to a personal device (e.g., a smartphone that is running a messaging application), and receiving responsive messages from the user in return.

Data processing apparatus for implementing ML models may also include, for example, special-purpose hardware accelerator units for processing common and compute-intensive parts of ML training or production (e.g., inference, workloads).

ML models may be implemented and deployed using a ML framework (e.g., a TensorFlow framework, a Microsoft Cognitive Toolkit framework, an Apache Singa framework, an Apache MXNet framework).

Implementations of the subject matter described in this specification may be realized in a computing system that includes a back-end component (e.g., as a data server) a middleware component (e.g., an application server), and/or a front-end component (e.g., a client computer having a graphical user interface, a web browser, or an app through which a user may interact with implementations of the subject matter described in this specification), or any combination of one or more such back-end, middleware, or front-end components. The components of the system may be interconnected by any form or medium of digital data communication (e.g., a communication network). Examples of communication networks include a local area network (LAN) and a wide area network (WAN) (e.g., the Internet).

The computing system may include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) may be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially be claimed as such, one or more features from a claimed combination may in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems may generally be integrated together in a single software product or packaged into multiple software products.

Particular implementations of the subject matter have been described. Other implementations are within the scope of the following claims. For example, the actions recited in the claims may be performed in a different order and still achieve desirable results. As one example, the processes depicted in the accompanying figures do not necessarily require the particular order shown, or sequential order, to achieve desirable results. In some cases, multitasking and parallel processing may be advantageous.

A number of implementations have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
receiving, by a server and from a computing device, data specifying a baseline query associated with an application;
determining, by the server, a workspace context of the application corresponding to the baseline query;
generating, by the server, a refined query by modifying the baseline query based on the workspace context;
obtaining, by the server and from one or more vector databases, data representing a vector representation that is semantically relevant to the refined query, wherein the vector representation is identified from among a plurality of vector representations based on the refined query;
generating, by the server, prompt data for one or more machine learning models based on the refined query and the vector representation;
obtaining data representing an output generated by the one or more machine learning models based on the prompt data; and
providing, to the computing device, an instruction that, when received by the computing device, causes the computing device to display a representation of the output data through the application.

2. The method of claim 1, wherein:
the baseline query is provided at a first time in relation to a graphical user interface of the application; and
the workspace context comprises one or more design elements displayed on the graphical user interface at the first time.

3. The method of claim 2, wherein the workspace context specifies a project type of a web application that is accessed through the application at the first time.

4. The method of claim 1, wherein the plurality of vector representations correspond to content chunks segmented from a multi-modal knowledge base of web design concepts.

5. The method of claim 4, further comprising:
accessing, by the server, content specified by a multi-modal knowledge base specified within a content management system associated with the application;
identifying a set of boundary conditions for the content specified by the multi-modal knowledge base; and
segmenting, by the server, the content from the multi-modal knowledge base into a plurality of content chunks.

6. The method of claim 5, wherein identifying the set of boundary conditions for the content specified by the multi-modal knowledge base comprises:
calculating a semantic similarity score between (i) a first text segment within content specified by the multi-modal knowledge base and (ii) a second text segment within content specified by the multi-modal knowledge base; and
determining that the semantic similarity score satisfies a predetermined semantic similarity threshold.

7. The method of claim 1, wherein the one or more machine learning models comprise a large language model (LLM).

8. The method of claim 1, wherein:
the data specifying the baseline query is received by the server at a first time point;
the instruction that causes the computing device to display the representation of the output data is provided by the server at a second time point; and
a time period between the first time point and the second time point is less than a predetermined time threshold.

9. The method of claim 8, wherein the predetermined time is three seconds.

10. A system comprising:
one or more computing devices; and
one or more storage devices storing instructions that, when executed by the one or more computing devices, cause the one or more computing devices to perform operations comprising:
receiving, by a server and from a first computing device, data specifying a baseline query associated with an application;
determining, by the server, a workspace context of the application corresponding to the baseline query;
generating, by the server, a refined query by modifying the baseline query based on the workspace context;
obtaining, by the server and from one or more vector databases, data representing a vector representation that is semantically relevant to the refined query, wherein the vector representation is identified from among a plurality of vector representations based on the refined query;
generating, by the server, prompt data for one or more machine learning models based on the refined query and the vector representation;
obtaining data representing an output generated by the one or more machine learning models based on the prompt data; and
providing, to the first computing device, an instruction that, when received by the first computing device, causes the first computing device to display a representation of the output data through the application.

11. The system of claim 10, wherein:
the baseline query is provided at a first time in relation to a graphical user interface of the application; and
the workspace context comprises one or more design elements displayed on the graphical user interface at the first time.

12. The system of claim 11, wherein the workspace context specifies a project type of a web application that is accessed through the application at the first time.

13. The system of claim 10, wherein the plurality of vector representations correspond to content chunks segmented from a multi-modal knowledge base of web design concepts.

14. The system of claim 13, wherein the operations further comprise:
accessing, by the server, content specified by a multi-modal knowledge base specified within a content management system associated with the application;
identifying a set of boundary conditions for the content specified by the multi-modal knowledge base; and
segmenting, by the server, the content from the multi-modal knowledge base into a plurality of content chunks.

15. The system of claim 14, wherein identifying the set of boundary conditions for the content specified by the multi-modal knowledge base comprises:
calculating a semantic similarity score between (i) a first text segment within content specified by the multi-modal knowledge base and (ii) a second text segment within content specified by the multi-modal knowledge base; and
determining that the semantic similarity score satisfies a predetermined semantic similarity threshold.

16. At least one non-transitory storage device storing instructions that, when executed by one or more processors, cause the one or more processors to perform operations comprising:
receiving, by a server and from a computing device, data specifying a baseline query associated with an application;
determining, by the server, a workspace context of the application corresponding to the baseline query;
generating, by the server, a refined query by modifying the baseline query based on the workspace context;
obtaining, by the server and from one or more vector databases, data representing a vector representation that is semantically relevant to the refined query, wherein the vector representation is identified from among a plurality of vector representations based on the refined query;
generating, by the server, prompt data for one or more machine learning models based on the refined query and the vector representation;
obtaining data representing an output generated by the one or more machine learning models based on the prompt data; and
providing, to the computing device, an instruction that, when received by the computing device, causes the computing device to display a representation of the output data through the application.

17. The storage device of claim 16, wherein:
the baseline query is provided at a first time in relation to a graphical user interface of the application; and
the workspace context comprises one or more design elements displayed on the graphical user interface at the first time.

18. The storage device of claim 17, wherein the workspace context specifies a project type of a web application that is accessed through the application at the first time.

19. The storage device of claim 16, wherein the plurality of vector representations correspond to content chunks segmented from a multi-modal knowledge base of web design concepts.

20. The storage device of claim 19, wherein the operations further comprise:
accessing, by the server, content specified by a multi-modal knowledge base specified within a content management system associated with the application;
identifying a set of boundary conditions for the content specified by the multi-modal knowledge base; and
segmenting, by the server, the content from the multi-modal knowledge base into a plurality of content chunks.
